(19) United States
(12) Patent Application Publication
(10) Pub. No.: US 2025/0027547 A1
(43) Pub. Date: Jan. 23, 2025

(54) Safety Caliper Cover

(71) Applicant: Zhangzhou Chemarulong Automotive Technology Co., Ltd., Zhangzhou (CN)

(72) Inventor: Shunjuan HU, Zhangzhou (CN)

(21) Appl. No.: 18/279,505

(22) PCT Filed: Apr. 25, 2023
(86) PCT No.: PCT/CN2023/090461

§ 371 Date: Aug. 30, 2023

(30) Foreign Application Priority Data
Aug. 1, 2022 (CN) 202222001427.6

(51) Int. Cl. F16D 65/00; F16D 55/00

(52) U.S. Cl. CPC F16D 65/0081; F16D 2055/0037

(57) ABSTRACT

A safety caliper cover is provided, which relates to the technical field of automobile accessories. The safety caliper cover includes a cover body, safety buckles, and locking pieces. A length direction of the cover body is an X-direction, a width direction of the cover body is a Y-direction, and a thickness direction of the cover body is a Z-direction. The cover body covers an outer surface side of a caliper of a wheel hub of an automobile. Z-direction connecting columns are arranged on an inner surface of the cover body. The safety buckle includes a fastening piece and a Z-direction connecting lug connected to the fastening piece. The Z-direction connecting lug corresponds to the Z-direction connecting column. The locking piece is used for penetrating through the Z-direction connecting lug to be locked with the Z-direction connecting column.

### TECHNICAL FIELD

The present disclosure relates to the technical field of automobile accessories, and in particular, to a safety caliper cover.

### BACKGROUND

A caliper is arranged on a wheel hub. The caliper achieves an effect of braking. When the caliper is mounted on the wheel hub, the caliper has an exposed outer surface, an inner surface opposite to the outer surface, a lower surface close to a center of the wheel hub, an upper surface opposite to the lower surface, and two side surfaces.

The safety caliper cover is mounted on the caliper of the wheel hub of an automobile to cover the outer surface to achieve effects of decorating and heat dissipating. There are various styles of calipers, as well as the various shapes and various fixing structures of safety caliper covers.

However, most of the existing safety caliper covers have the problems such as complex structure, inconvenience in mounting, insufficient mounting strength, numerous fixing parts, or poor adaptation.

### SUMMARY

The present disclosure provides a safety caliper cover to solve the technical problems such as complex structure and inconvenience in mounting of the safety caliper cover in the related art.

In order to solve the technical problems above, one technical solution adopted by the present disclosure is that: a safety caliper cover is provided. The safety caliper cover includes a cover body, a safety buckle, and a locking piece. A length direction of the cover body is an X-direction, a width direction of the cover body is a Y-direction, and a thickness direction of the cover body is a Z-direction.

The cover body covers an outer surface side of a caliper of a wheel hub of an automobile. Z-direction connecting columns are arranged on an inner surface of the cover body; each of the safety buckles comprises a fastening piece and a Z-direction connecting lug connected to the fastening piece; the Z-direction connecting lug corresponds to one of the Z-direction connecting columns; a corresponding one of the locking pieces is used for locking with the one of the Z-direction connecting columns; and the fastening piece extends in at least two directions of the X-direction, the Y-direction, and the Z-direction, and forms a limit contact fit with an outer surface of the caliper.

According to a specific embodiment of the present disclosure, the fastening piece includes a Y-direction extension piece. The Z-direction connecting lug is arranged on one side, deviating from the caliper, of the Y-direction extension piece.

According to a specific embodiment of the present disclosure, the fastening piece includes an X-direction extension piece connected with the Y-direction extension piece. The X-direction extension piece is bent at an angle or bent in an arc shape.

According to a specific embodiment of the present disclosure, the fastening piece includes a Z-direction extension piece connected with the Y-direction extension piece. There is one or more right angle bends between the Z-direction extension piece and the Y-direction extension piece.

According to a specific embodiment of the present disclosure, the X-direction connection piece is disconnected from or connected with the Z-direction extension piece.

According to a specific embodiment of the present disclosure, the Z-direction connecting columns are integrally molded with the cover body.

According to a specific embodiment of the present disclosure, the safety buckle is an integrally molded structural part.

According to a specific embodiment of the present disclosure, the Z-direction connecting lug is connected to an outer end of the Z-direction connecting column in a sleeving manner.

According to a specific embodiment of the present disclosure, one end of the Z-direction connecting lug which is butted with the one of the Z-direction connecting columns is flush with or is protruded from one side, close to the cover body, of the fastening piece.

According to a specific embodiment of the present disclosure, for each of the locking pieces, the locking piece is a screw bolt or a screw, and penetrates through the Z-direction connecting lug to be locked with the one of the Z-direction connecting columns.

Or the locking piece is a nut; the one of the Z-direction connecting columns is provided with external screw threads; the Z-direction connecting lug is connected to the one of the Z-direction connecting columns in a sleeving manner and is matched and locked with the external screw threads through the nut.

Or the locking piece is a circlip; the one of the Z-direction connecting columns is provided with a clamping groove; and the Z-direction connecting lug is connected to the one of the Z-direction connecting columns in the sleeving manner and is matched and locked with the clamping groove through the circlip.

The present disclosure has the following beneficial effects.

It is different from the related art that, the safety caliper cover provided by the present disclosure is novel in structure, convenient to manufacture, convenient to assemble, and safe and reliable.

### BRIEF DESCRIPTION OF THE DRAWINGS

To describe the technical solutions in the implementation manners of the present disclosure more clearly, the following briefly describes the accompanying drawings required for describing the implementation manners. Apparently, the accompanying drawings in the following description are merely some implementation manners of the present disclosure, and those of ordinary skill in the art may still derive other drawings from these accompanying drawings without creative efforts.

FIG. 1 is a schematic diagram of a three-dimensional structure of a safety caliper cover provided by a first embodiment of the present disclosure.

FIG. 2 is a schematic diagram of a three-dimensional structure of a safety caliper cover provided by a second embodiment of the present disclosure.

FIG. 3 is a schematic diagram of a three-dimensional structure of a safety caliper cover provided by a third embodiment of the present disclosure.

FIG. 4 is a schematic diagram of a three-dimensional structure of a safety caliper cover provided by a fourth embodiment of the present disclosure.

FIG. 5 is a schematic diagram of a three-dimensional structure of a safety caliper cover provided by a fifth embodiment of the present disclosure.

FIG. 6 is a schematic diagram of a three-dimensional structure of a safety caliper cover provided by a sixth embodiment of the present disclosure.

Reference signs in the drawings: 10—cover body; 100—Z—direction connecting column; 20—safety buckle; 210—fastening piece; 211-Y—direction extension piece; 212-X—direction extension piece; 213-Z—direction extension piece; and 220-Z—direction connecting lug.

### DETAILED DESCRIPTION OF THE EMBODIMENTS

The present disclosure will be further described in detail below with reference to the accompanying drawings and implementation manners. It is particularly pointed out that, the following implementations manners are merely used for describing the present disclosure, but do not constitute a limitation to the scope of the present disclosure. Similarly, the following implementation manners are merely part but not all of the implementation manners of the present disclosure. All other implementation manners obtained by those of ordinary skill in the art belong to the scope of protection of the present disclosure.

The terms “first”, “second”, and “third” in the present disclosure are merely used for description and cannot be understood as indicating or implying relative importance or implicitly indicating the number of indicated technical features. Therefore, features defined by “first”, “second”, and “third” may explicitly or implicitly include one or more features. In the description of the present disclosure, “a plurality of” means at least two manners, for example, two, three, or the like, unless otherwise limited explicitly and specifically. All directional indications (such as upper, lower, left, right, front, rear, . . . ) in the implementation manners of the present disclosure are merely used for explaining relative position relationships, movement situations, and the like among various parts under a specific attitude (as shown in the accompanying drawings). If the specific attitude changes, the directional indication will change accordingly. In addition, the terms “include” and “have” and any variations thereof are intended to cover non-exclusive inclusions. Manners, for example, a process, a method, a system, a product, or a device that includes a series of steps or units is not limited to the listed steps or units, and instead, optionally, further includes a step or unit that is not listed, or optionally, further includes another step or unit that is intrinsic to the process, the method, the product, or the device.

“Implementation manners” mentioned herein means that particular features, structures, or characteristics described with reference to the implementation manners may be included in at least one embodiment of the present disclosure. The appearances of the phrases in various positions in the specification do not necessarily refer to the same implementation manners, and are not independent or alternative implementation manners that are mutually exclusive to other implementation manners. A person skilled in the art explicitly or implicitly understands that the implementation manners described herein may be combined with other implementation manners.

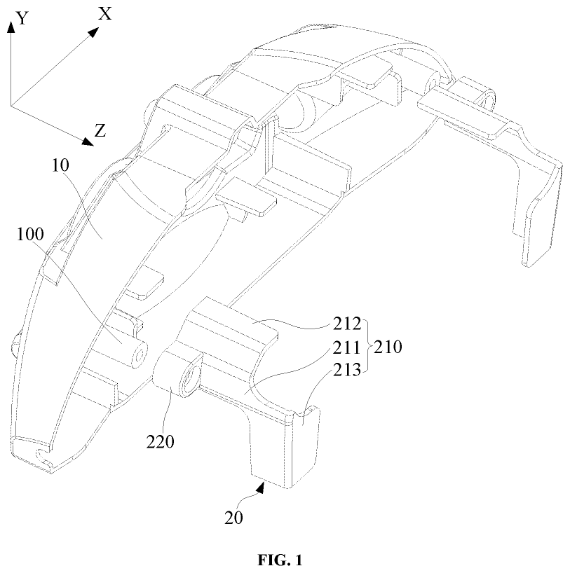

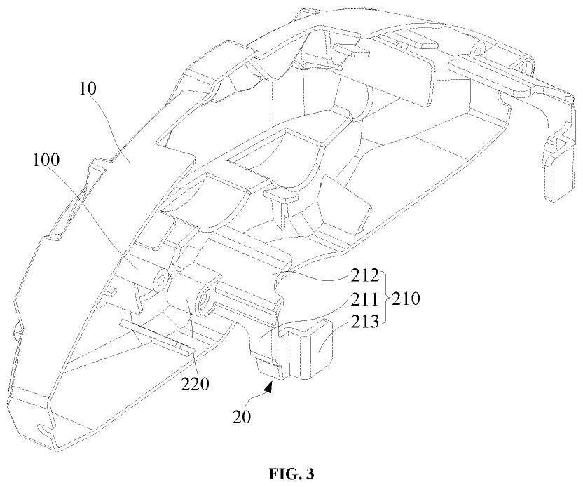

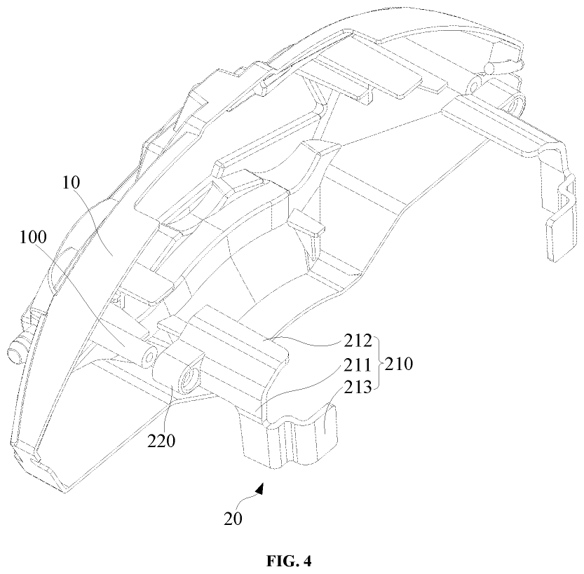

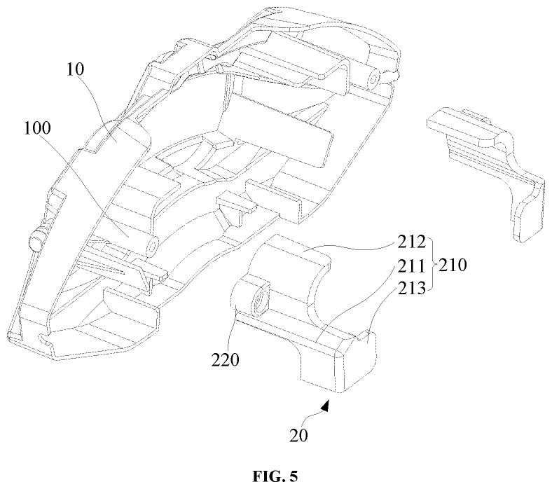

As shown in FIG. 1 to FIG. 6, the present disclosure provides a safety caliper cover. The safety caliper cover includes a cover body 10, safety buckles 20, and locking pieces (not shown in the figures).

An outer surface of the cover body 10 may be designed to have various decorative patterns and is configured to have various colors. There are one pair of safety buckles 20 and locking pieces, which are arranged on both sides of a length direction of the cover body 10 and are assembled on an inner surface side of the cover body 10. Generally, the safety buckles 20 and the locking pieces may be symmetrically arranged relative to the cover body 10. The locking piece may be a screw bolt, a screw, a nut, a circlip, or the like.

As shown in FIG. 1, a length direction of the cover body 10 is an X-direction, a width direction of the cover body 10 is a Y-direction, and a thickness direction of the cover body 10 is a Z-direction. Directions in other figures refer to an XYZ coordinate system as shown in FIG. 1.

The cover body 10 covers an outer surface side of a caliper (not shown in the figure) of a wheel hub of an automobile. Z-direction connecting columns 100 are arranged on an inner surface of the cover body 10. The Z-direction connecting column 100 may be cylindrical. An axial connecting hole may be formed in a center of the Z-direction connecting column 100. The axial connecting hole may be a screw hole or a polished hole to enable a screw bolt or a screw to screw in. When the axial connecting hole is the polished hole, the screw bolt or the screw are locked in by tapping, which is mounted more securely and reliably. The Z-direction connecting column 100 may also be provided with external screw threads, and correspondingly, the locking piece is a nut. A radial ring clamping groove may also be formed in the periphery of the Z-direction connecting column 100, and correspondingly, the locking piece is a circlip matched with the clamping groove.

The safety buckle 20 includes a fastening piece 210 and a Z-direction connecting lug 220 connected to the fastening piece 210. The Z-direction connecting lug 220 corresponds to the Z-direction connecting column 100. The Z-direction connecting lug 220 is provided with an axial through hole corresponding to the Z-direction connecting column 100.

The locking piece is used for locking with the Z-direction connecting column 100. When the locking piece is a screw bolt or a screw, one end, used for enabling the locking piece to screw in, of the Z-direction connecting lug 220 is a counter bore, which may receive countersunk head assembly of the locking piece.

The fastening piece 210 extends in at least two directions of the X-direction, the Y-direction, the Z-direction, and forms a limit contact fit with an outer surface of the caliper. The so-called extension in the present disclosure is not limited to horizontal extension, but may also be bending extension.

Specifically, the fastening piece 210 includes a Y-direction extension piece 211. The Z-direction connecting lug 220 is arranged on one side, deviating from the caliper, of the Y-direction extension piece 211. That is, the Z-direction connecting lug 220 is arranged on the outer surface side of the fastening piece 210. The inner surface sides of a pair of safety buckles 20 are used for clamping the caliper. The Y-direction extension piece 211 is used for pressing and fitting a side surface of the caliper.

The fastening piece 210 includes an X-direction extension piece 212 connected with the Y-direction extension piece 211. The X-direction extension piece 212 is bent at an angle or bent in an arc shape to be adapted, pressed, and fit with a local upper surface of the caliper.

The fastening piece 210 includes a Z-direction extension piece 213 connected with the Y-direction extension piece 211. There is one or more right angle bends between the Z-direction extension piece 213 and the Y-direction extension piece 211 to correspond to a surface structure of different models of calipers.

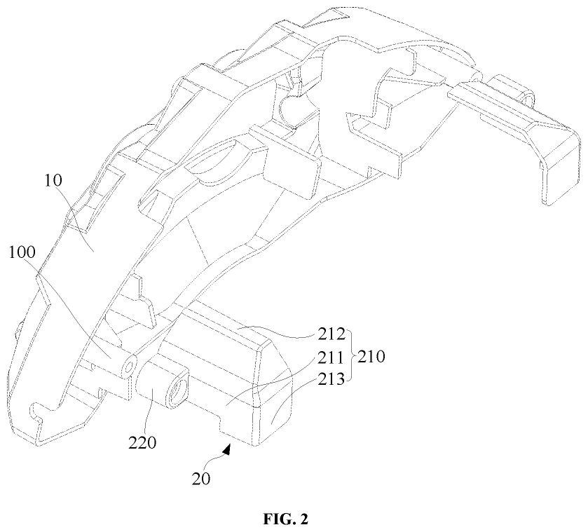

The X-direction connection piece 212 is disconnected from or connected with the Z-direction extension piece 213 (FIG. 2) to correspond to surface structures of different models of calipers.

In the embodiment of the present disclosure, the Z-direction connecting column 100 is integrally molded with the cover body 10. The safety buckle 20 is an integrally molded structural part, which is relatively convenient and fast to manufacture, and has good safety and stability.

An inside diameter of the Z-direction connecting lug 220 is relatively large, which may be connected to an outer end of the Z-direction connecting column 100 in a sleeving manner so as to facilitate assembling. The inside diameter of the Z-direction connecting lug 220 may be in a stepped cavity shape to facilitate positioning and connecting in a sleeving manner.

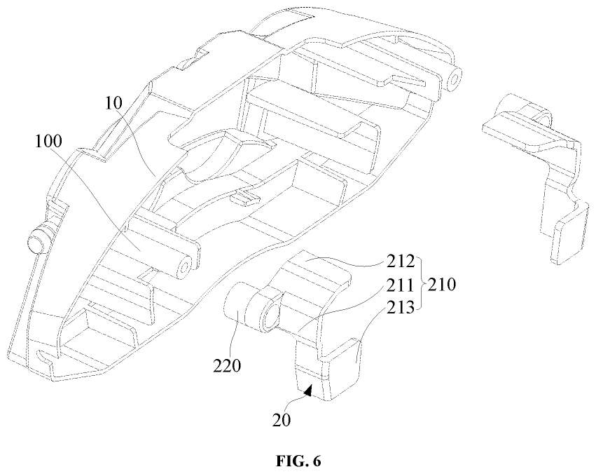

One end of the Z-direction connecting lug 220 which is butted with the Z-direction connecting column 100 is flush with or is protruded from one side, close to the cover body 10, of the fastening piece 210 (see FIG. 6). When one end of the Z-direction connecting lug 220 which is butted with the Z-direction connecting column 100 is flush with or is protruded from one side, close to the cover body 10, of the fastening piece 210, the mounting stability is further improved due to a great axial length of the Z-direction connecting lug 220.

In one embodiment, the locking piece is a screw bolt or a screw, and penetrates through the Z-direction connecting lug 220 to be locked with the Z-direction connecting column 100.

In another embodiment, the locking piece is a nut; the Z-direction connecting column 100 is provided with external screw threads; the Z-direction connecting lug 220 is connected to the Z-direction connecting column 100 in a sleeving manner and is matched and locked with the external screw threads through nut.

In another embodiment, the locking piece is a circlip; the periphery of the Z-direction connecting column 100 is provided with a clamping groove; and the Z-direction connecting lug 220 is connected to the Z-direction connecting column 100 in a sleeving manner and is matched and locked with the clamping groove through the circlip.

In addition, the inner surface of the cover body 10 is provided with a plurality of positioning mounting rib plates to position and correct the caliper.

In conclusion, those skilled in the art easily understand that the safety caliper cover provided by the present disclosure is novel in structure, convenient to manufacture, convenient to assemble, and safe and reliable.

The above is merely preferred implementation manners of the present disclosure and does not limit the scope of protection of the present disclosure. Equivalent devices or equivalent flowchart transformations made by using the contents of the specification and the accompanying drawings of the present disclosure, or direct or indirect application in other relevant technical fields are similarly included in the patent scope of protection of the present disclosure.

What is claimed is:

1. A safety caliper cover, comprising a cover body, safety buckles, and locking pieces, wherein a length direction of the cover body is an X-direction, a width direction of the cover body is a Y-direction, and a thickness direction of the cover body is a Z-direction;
the cover body covers an outer surface side of a caliper of a wheel hub of an automobile; Z-direction connecting columns are arranged on an inner surface of the cover body; each of the safety buckles comprises a fastening piece and a Z-direction connecting lug connected to the fastening piece; the Z-direction connecting lug corresponds to one of the Z-direction connecting columns; a corresponding one of the locking pieces is used for locking with the one of the Z-direction connecting columns; and the fastening piece extends in at least two directions of the X-direction, the Y-direction, and the Z-direction, and forms a limit contact fit with an outer surface of the caliper.

2. The safety caliper cover according to claim 1, wherein the fastening piece comprises a Y-direction extension piece; and the Z-direction connecting lug is arranged on one side, deviating from the caliper, of the Y-direction extension piece.

3. The safety caliper cover according to claim 2, wherein the fastening piece comprises an X-direction extension piece connected with the Y-direction extension piece; and the X-direction extension piece is bent at an angle or bent in an arc shape.

4. The safety caliper cover according to claim 3, wherein the fastening piece comprises a Z-direction extension piece connected with the Y-direction extension piece; and there is one or more right angle bends between the Z-direction extension piece and the Y-direction extension piece.

5. The safety caliper cover according to claim 4, wherein the X-direction connection piece is disconnected from or connected with the Z-direction extension piece.

6. The safety caliper cover according to claim 1, wherein the Z-direction connecting columns are integrally molded with the cover body.

7. The safety caliper cover according to claim 4, wherein each of the safety buckles is an integrally molded structural part.

8. The safety caliper cover according to claim 1, wherein the Z-direction connecting lug is connected to an outer end of the one of the Z-direction connecting columns in a sleeving manner.

9. The safety caliper cover according to claim 1, wherein one end of the Z-direction connecting lug which is butted with the one of the Z-direction connecting columns is flush with or is protruded from one side, close to the cover body, of the fastening piece.

10. The safety caliper cover according to claim 1, wherein
for each of the locking pieces, the locking piece is a screw bolt or a screw, and penetrates through the Z-direction connecting lug to be locked with the one of the Z-direction connecting columns; or
the locking piece is a nut; the one of the Z-direction connecting columns is provided with external screw threads; the Z-direction connecting lug is connected to the one of the Z-direction connecting columns in a sleeving manner and is matched and locked with the external screw threads through the nut; or
the locking piece is a circlip; the one of the Z-direction connecting columns is provided with a clamping groove; and the Z-direction connecting lug is connected to the one of the Z-direction connecting columns in the sleeving manner and is matched and locked with the clamping groove through the circlip.
